(19) United States
(12) Patent Application Publication
(10) Pub. No.: US 2009/0229981 A1
(43) Pub. Date: Sep. 17, 2009

(54) LIQUID DISINFECTANT APPARATUS

(76) Inventor: Mark R. DeSanto, Mokena, IL (US)

Correspondence Address: MICHAEL BEST & FRIEDRICH LLP, 100 E WISCONSIN AVENUE, Suite 3300, MILWAUKEE, WI, 53202, US

(21) Appl. No.: 12/402,711

(22) Filed: Mar. 12, 2009

Related U.S. Application Data
(60) Provisional application No. 61/069,112, filed on Mar. 12, 2008.

(51) Int. Cl. C02F 1/469

(52) U.S. Cl. 204/554; 204/672; 204/663

(57) ABSTRACT

A liquid purification apparatus, including a flow cell having an opening at each end for conducting a liquid therethrough. The liquid purification apparatus also includes a pair of electrode plates disposed within the flow cell, each electrode plate comprising an elongated rectangle having a length, width, and thickness, the length and width defining a face of each electrode plate, the width being greater than the thickness. The electrode plates are arranged such that the faces of the electrode plates are parallel and opposite one another with a gap therebetween.

Priority is hereby claimed to U.S. Provisional Patent App. No. 61/069,112 filed on Mar. 12, 2008, the entire contents of which are incorporated herein by reference.

### BACKGROUND

Embodiments of the invention relate generally to liquid disinfectant devices that rely on the introduction of copper and/or silver ions into a water stream.

Certain metal ions, for example copper and silver ions, can be used for disinfecting a liquid. In one arrangement, a group of copper-silver alloy electrodes are aligned in a flow cell with a DC current and voltage applied to the electrodes, so that ions are released into the liquid that flows through the cell and promotes killing of microorganisms.

The emissions of an ionization process include surface-active cations, which provide a potent biocide. The disinfection action is attributable to the positively-charged copper and silver ions which form electrostatic bonds with negatively charged sites on microorganism cell walls. These electrostatic bonds create stresses which lead to distorted cell wall permeability, reducing the normal intake of life-sustaining nutrients. This action, coupled with protein denaturation, leads to cell lysis and death. Bacteria are killed rather than merely suppressed as in the case with alternative control methods. These ions eradicate or minimize various microorganisms in liquids, including but not necessarily limited to: Legionella, E. coli, Salmonella, M. avium, Listeria, Staphylococcus and Pseudomonas aeriginosa.

### SUMMARY OF THE INVENTION

In one embodiment, the invention is a liquid purification apparatus, including a flow cell having an opening at each end for conducting a liquid therethrough. The liquid purification apparatus also includes a pair of electrode plates disposed within the flow cell, each electrode plate comprising an elongated rectangle having a length, width, and thickness, the length and width defining a face of each electrode plate, the width being greater than the thickness. The electrode plates are arranged such that the faces of the electrode plates are parallel and opposite one another with a gap therebetween.

In another embodiment, the invention is a method of disinfecting a liquid. The method includes providing a flow cell having an opening at each end for conducting a liquid therethrough. The method also includes disposing a pair of electrode plates disposed within the flow cell, each electrode plate comprising an elongated rectangle having a length, width, and thickness, the length and width defining a face of each electrode plate, the width being greater than the thickness. The electrode plates are arranged such that the faces of the electrode plates are parallel and opposite one another with a gap therebetween. The method also includes applying a voltage to the electrode plates and contacting the electrode plates with the liquid.

### BRIEF DESCRIPTION OF THE DRAWINGS

Other objects and advantages of the invention will become apparent upon reading the following detailed description and upon reference to the accompanying drawings in which:

FIG. 1 is a perspective view of a flow cell, partially broken away and illustrating a prior art electrode configuration;

FIG. 2 is a cross-section through line 2-2′ of the electrode arrangement from the flow cell of FIG. 1;

FIG. 3 is schematic sketch of a pair of opposed electrodes of the prior arrangement of FIG. 1 taken along a plane that is perpendicular to the longitudinal axis of the electrode and the direction of flow through the flow cell to illustrate the type of uneven material sacrificing that occurs and results in dome-shaped operating surfaces on the electrodes;

FIG. 4 is a drawing of a prior art electrode arrangement illustrating its condition upon initial installation and early in its operational cycle;

FIG. 5 is a drawing of a prior art electrode arrangement illustrating the coating of the electrode surface that occurs as water borne minerals are deposited out of the water stream onto the electrodes during operation;

FIG. 6 is another drawing of a prior art electrode arrangement illustrating the advanced state of coating of the electrode surface with water borne minerals as the operational cycle of the electrodes goes forward;

FIG. 7 is an end view, partially in perspective, of an electrode configuration constructed and arranged in accordance with this invention and prior to the start of its operational cycle;

FIG. 8 is an end view of the electrode assembly of FIG. 7 from a different angle;

FIGS. 9, 10, and 11 are perspective views of pairs of electrodes configured in accordance this invention;

FIG. 12 is an end view, in perspective, of a portion flow cell with an electrode assembly that is constructed and arranged in accordance with this invention but with a different thickness (i.e. thinner) than that of FIGS. 7 and 8, and prior to the start of its operational cycle;

FIGS. 13 and 14 are end views, in perspective, of electrodes such as those of FIG. 12 after extended operation in a flow cell and illustrating the type of material sacrificing that occurs with electrodes of this invention, this is also illustrative of material sacrificing that occurs with the thicker electrodes such as those in FIGS. 7 and 8;

FIG. 15 is a perspective view of a flow cell, partially broken away and illustrating an electrode configuration of the present invention;

FIG. 16 is a cross-section through line 16-16′ of the electrode arrangement from the flow cell of FIG. 15; and

FIG. 17 is a partial cutaway side view of a flow cell showing a pair of support blocks and an electrode within the flow cell.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items.

Certain metal ions, such as copper and silver ions, can be used for liquid purification. A typical electrode arrangement is one wherein copper and silver alloyed or compounded bars are in the form of elongate electrodes that are square in cross section. The present invention can be used with alloys having various compositions, including various materials in varying percentages, but in one embodiment the alloy has 30% silver and 70% copper. The electrodes are disposed within a flow cell so that ions are released into the liquid passing through. A flow cell typically includes a cylindrical housing (although other shapes are possible) having an opening at each end through which a liquid (usually water) passes. The flow cell generally includes connectors or is otherwise adapted at each end to be joined to a flow system. In one embodiment, the flow cell is constructed from C-PVC plastic. In various embodiments, the flow cell and other components of the liquid disinfecting system described herein are made from materials that are approved by the National Sanitation Foundation (NSF).

In the prior art system, the electrode bars are arranged in the flow cell as a subassembly of juxtaposed pairs, such that two pairs of juxtaposed pairs, totaling four in number, are arranged with the longitudinal axes of the bars being parallel to direction of liquid flow. In some cases, two such subassemblies are used, arranged end to end, so that there are four pairs of electrodes arranged with their longitudinal axes being parallel to each other and parallel to the direction of liquid flow. A typical dimension for the individual bars is one inch square by seven inches long. Electrodes of this arrangement are described in U.S. Pat. Nos. 6,126,820 and 6,325,944, each incorporated herein by reference in its entirety.

In normal operation the electrodes are sacrificially consumed under the influence of what is typically a direct-current (DC) electric voltage applied across the electrodes. One of the electrodes serves as cathode and the other as anode. In some embodiments, the polarity of the applied DC voltage is reversed occasionally (i.e. the electrode that was cathode becomes the anode, and vice versa). The system can include a controller with a power supply that can apply up to 100 volts DC at up to 10 amps of current, although other power levels are also possible. The DC voltage applied to the electrodes in turn influences an electric current that passes through the water from one electrode to the other. It is expected that in normal operation the electrodes will be consumed (since ions are released from the electrodes into the liquid) and will eventually need replacement.

Although sacrificial consumption of the electrodes is expected, the consumption experienced in the current conventional electrode configuration has been an ongoing problem presenting a number of undesirable product and operational situations. Among the problems are: (i) the electrodes have a reduced useful life; (ii) the electrodes erode in a manner which rounds off the corners of the confronting, or opposed, electrode surfaces, producing a crowned surface on each electrode, which reduces the active surface area and therefore ion generation and/or degrades the effectiveness of operation; and (iii) the rounding and crowning of electrodes leads to a need for early replacement, resulting in an inordinate amount of electrode material scrap.

The electrodes may also be subject to erosion by the water that is running through the flow cell and being treated. Erosion is caused by the water flow over and past the electrodes and is in addition to, and is to be distinguished from, the sacrificial phenomena inherent in normal operation.

Yet another problem with the prior art electrode arrangements is that the electrodes become coated with calcium, magnesium, and other minerals that are present in the water being treated. This can be detrimental to effective ion generation and, thus, to operation of the flow cell disinfectant system. The presence of a mineral coating requires periodic cleaning and/or replacement of the electrodes.

The asymmetrical wearing (e.g. rounded corners) and coating can have a negative impact on the electrical qualities of the system. The amount of voltage available at most building or other sites where the disinfectant system may be installed is limited, typically to about 100 volts DC. As wear and/or coating progress, the amount of voltage required to achieve desired ion generation increases, ultimately reaching the upper limit of available voltage, at which point the efficacy of the system begins to diminish. Furthermore, operating at higher voltage levels increases the heat that is generated in and around the electrodes.

Extended, continuous system operation is the goal of an efficient treatment system. The problems discussed above run contrary to that desired objective.

Thus, objects of the present invention include extending the life of the electrodes, reducing the amount of scrap material remaining when an electrode has reached the end of its useful life, and improving the basic operation of the system.

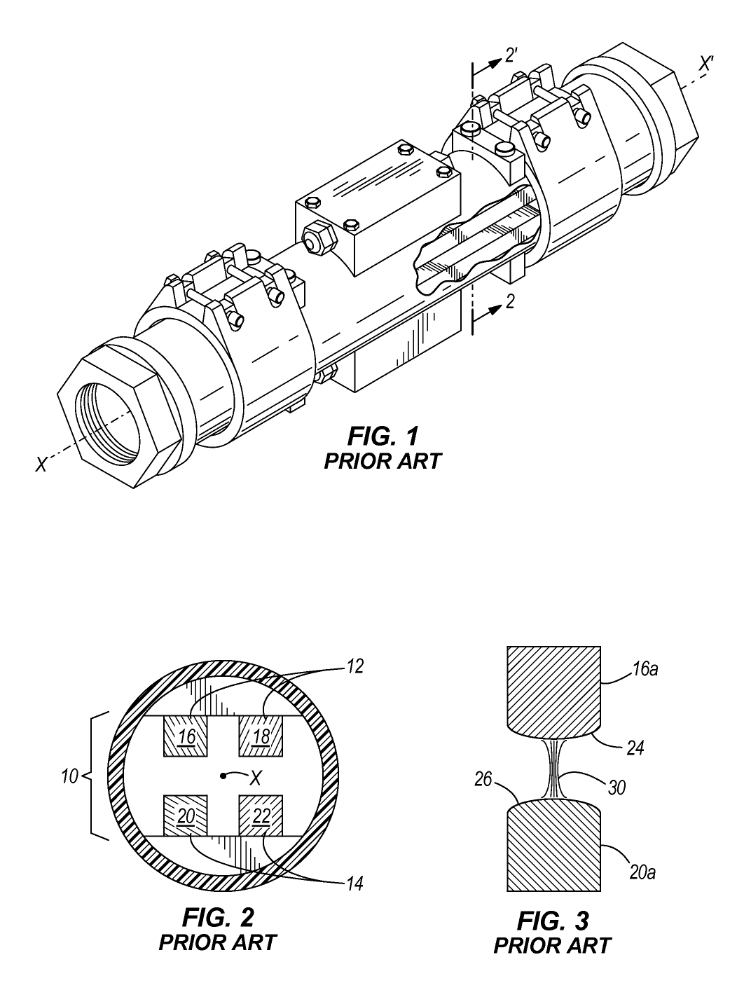

A brief description of a typical prior art arrangement will assist in the understanding of advances achieved by this invention. In FIGS. 1 and 2, a prior art electrode assembly 10 is shown, the assembly 10 being made up of two opposed pairs 12 and 14 of electrodes 16, 18, 20 and 22. The directly opposed surfaces 17, 19 and 21, 23 of the electrodes are the operative electrode surfaces insofar as current flows between each pair of these surfaces. It is from these surfaces that ions are generated (sacrificed) and it is also these surfaces that are subject to erosion.

The prior art electrodes are square bars, for example one inch by one inch in cross-section and seven inches in length. Thus, each electrode provides seven square inches of operative surface area, or a total of twenty-eight square inches of operative surface, when four pairs of electrodes are used. When four pairs of electrodes are used, the electrodes may be arranged in the flow cell in two groups of four electrodes arranged end to end in the direction of water flow.

A reference point for electrode orientation is selected as the longitudinal axis X-X′ of the flow cell illustrated in perspective in FIG. 1 and in cross-section in FIG. 2. The axis is depicted as point X in FIG. 2. The electrodes 16, 18, 20, and 22 are arranged with their longitudinal axes parallel to the longitudinal axis X.

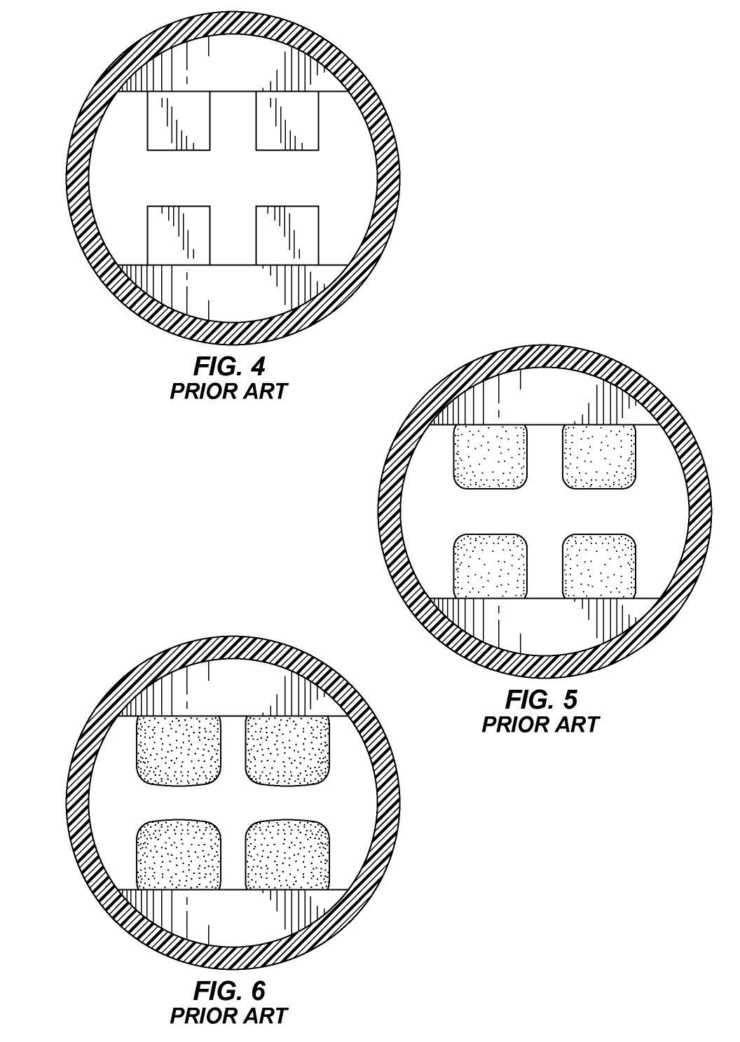

After use in a typical water system the electrodes 16a and 20a become rounded as illustrated in FIG. 3. This results in the facing operating surfaces of all of the electrode pairs becoming generally dome-shaped and presenting opposed domed surfaces 24 and 26. This is to be compared to the flat opposed surfaces of the fresh electrodes in FIGS. 1 and 2. Only one pair of electrodes is illustrated in FIG. 3 but this discussion applies equally as well to the other pairs in the cell.

The operational significance of the dome shape is that the current flow influenced through the water by a voltage applied across the electrodes will seek the shortest path. This concentrates the current between the outermost portions of the domed surfaces, i.e. along line 30 in FIG. 2 which is illustrative of the path that most of the current will follow under these conditions.

Using fresh electrodes, current will flow between the opposed electrode surfaces across the entire operative surface. That exposes considerably more electrode surface to electric energy and thus results in greater ion generation for a given voltage across the electrodes compared to the amount of ion generation that will result from the current being concentrated at the outermost tip of the domed electrodes (FIG. 3). The less operational surface area available from the positive and negatively charged electrodes, the more voltage that will be required to pass the same amount of current. As a result, more electrical energy will be required to maintain a desired level of ion generation when the operative surfaces become dome-shaped than is required when the surfaces are flat.

With reference to FIGS. 5 and 6, in use the prior art configuration illustrated in FIGS. 1 and 2 may be subject to a build up of a coating on the electrodes. The coating is the result of minerals, such as calcium, magnesium, etc. in the water being deposited out onto the electrodes. This coating may appear as a bluish film on electrodes that have been in use for some time, such as the electrodes shown in FIGS. 5 and 6. FIGS. 4, 5, and 6 illustrate the progressive build up of coating from initial installation (FIG. 4) through the operational cycle of the unit (FIGS. 5 and 6). The coating that occurs on the prior art electrodes can act as an insulator, increasing electrical resistance in the context of the electric phenomena that occurs between the opposed electrodes. This also increases the amount of electrical energy that is required to maintain the desired electric current level and degree of ion generation.

As the just-described coating increases and rounding of the electrode progresses, an increasing amount of voltage is required to maintain ion generation. Eventually the upper limit of voltage available for application across the electrodes (typically 100 V) may be reached, such that no more voltage is available for application to the electrodes, and ion generation falls off. As this condition progresses the electrodes may need to have the mineral coating periodically cleaned off. As coating/cleaning and rounding of the electrodes progresses, a point will be reached where the operational surface area of the electrodes may become too small and the electrodes may have to be replaced.

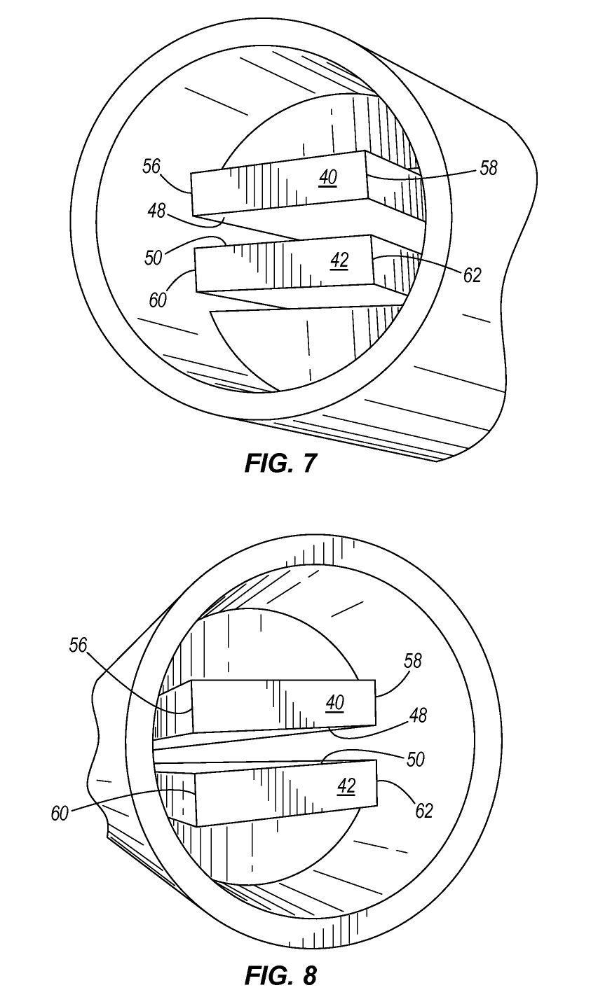

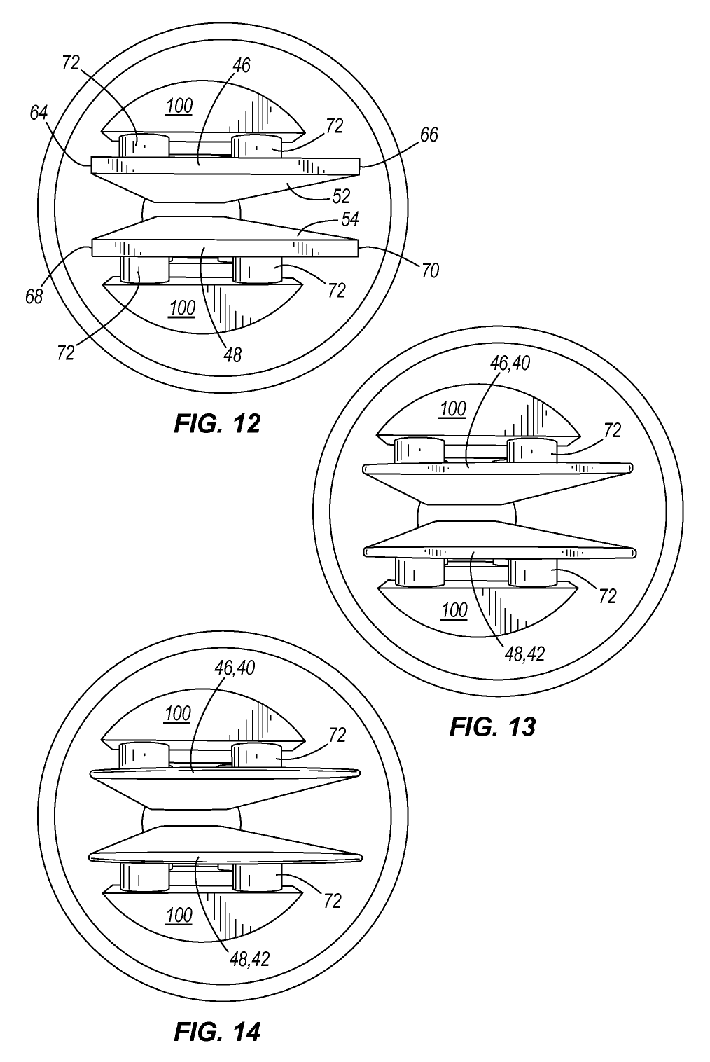

This invention proposes an electrode configuration where a pair of wider electrodes 40 and 42 are arranged in the flow chamber, see FIGS. 7 and 8. The electrode configuration of the present invention is wider than the prior art arrangement just described above, for example two and one half inches wide as opposed to one inch. In FIG. 12 the electrodes have the same width as in FIGS. 7 and 8 but are thinner, for example the electrodes in FIG. 12 are three sixteenths of an inch thick compared to the five eighths inch thick electrodes of FIGS. 7 and 8. Other electrode thicknesses and dimensions are also possible.

In one embodiment of this invention, the individual electrodes are each two and a half inches wide, five-eighths of an inch thick, and fourteen inches long. This provides an operative surface area of thirty-five square inches if two electrodes are used and seventy square inches if two sets of such electrodes are used. With reference to FIGS. 7, 8, and 12, the longitudinal axes of electrodes 40, 42 and 44, 46 are arranged parallel to the longitudinal axis X of the flow cell. The operational surfaces 48, 50 and 52, 54 of the electrodes 40, 42 are flat, planar surfaces that are directly opposed one to one other.

The electrodes 40 and 42 have lateral faces 56, 58 and 60, 62, respectively. Faces 56 and 60 are adjacent to a portion of an inner wall of the flow cell and the other faces 58 and 62 are adjacent an inner wall portion of the flow cell that is diametrically opposite to the inner wall portion of the flow cell to which edges 56, 60 are adjacent. Therefore, the electrodes extend continuously from one edge to the other, defining a continuous ion generating electrode operating surface across the flow cell. This defines a water flow passage between the flat, planar electrode operating surfaces. The operating surfaces extend from adjacent one interior portion of the flow cell wall continuously across the center line of the flow cell (axis X) to a diametrically opposite portion of the internal flow cell wall. Relative to water flow this defines a flow passage between the operating surfaces of the electrodes that is continuous and uninterrupted, and which encompasses the mid portion of the flow cell (axis X) and extensions on both sides of that mid portion up to portions of diametrically opposite portions of inner walls of the flow cell.

Similarly, and with reference to FIG. 12, electrodes 46 and 48 have edges 64, 66 and 68, 70, respectively. Edges 64 and 68 are adjacent to a portion of an inner wall of the flow cell and the other edges 66 and 70 are adjacent an inner wall portion of the flow cell that is diametrically opposite to the inner wall portion of the flow cell to which edges 64, 68 are adjacent. As in FIGS. 7 and 8, the electrodes extend continuously from one edge to the other defining a continuous ion generating electrode operating surface across the flow cell. This defines a water flow passage between the flat, planar electrode operating surfaces. The operating surfaces extend from adjacent one interior portion of the flow cell wall continuously across the center line of the flow cell (axis X) to a diametrically opposite portion of the internal flow cell wall. Relative to water flow this defines a flow passage between the operating surfaces of the electrodes that is continuous and uninterrupted, and which encompasses the mid portion of the flow cell (along axis X) and extensions on both sides of the mid-portion up to portions of diametrically opposite portions of inner walls of the flow cell.

It has been observed that the electrodes configured in accordance with this invention have operated over time with the following improved characteristics.

Erosion of the electrode material, to the extent this is present, is relatively uniform across the operational surfaces, eliminating the rounding or domed effect of the prior art configuration. The sacrificial consumption of the electrodes is also uniform across the operational surfaces of electrodes. This provides consistent ion generation within available voltage sources. It results in consumption of virtually the entire amount of available electrode material. The criteria determining when the electrodes have to be replaced becomes not when the electrodes cannot function adequately in response to the electrical power available but when it consumed beyond its physical, structural integrity. This also means little of the electrode material is left to scrap.

FIGS. 13 and 14 show electrodes 46, 48 or 40, 42 after extended usage. The same used electrodes are identified as both initial electrodes 46, 48 and 40, 42 because the phenomena of erosion and material sacrificing as well as lack of contaminate deposits is similar throughout various widths. These electrodes, which were initially five eighths or three sixteenths inches thick, have been sacrificed to a thinner condition but are still relatively uniform in thickness throughout. This attests to the fact that sacrificing of electrode material, and where it occurs, is uniform across the opposed operational surfaces.

Another advantage which has been observed is the electrodes of the present invention, over extended periods of usage, are not subjected to the coating of minerals from the water being treated. This can be seen, for example, in FIGS. 13 and 14, where the electrodes are not coated with the mineral deposits even after extended use.

Accordingly, the deleterious effects of uneven wear due to erosion or material sacrificing, and uneven coating with impurities, have each been reduced or eliminated. The electrodes of this invention are capable of extended, uninterrupted usage and continue to operate well within the voltage available from conventional power sources.

Whereas the prior art arrangements usually required cleaning on a monthly basis or more frequently and usually had to be replaced when substantial electrode material was still present, electrodes of this invention have operated without requiring cleaning for a period of months and the electrodes when discarded will have been substantially consumed and not left to scrap.

It is understood that the improved operation is the result of several unexpected operational phenomena.

Because the electrodes present a continuous surface to the water from one wall of the flow cell across the mid point of the cell (longitudinal axis X) to an opposite portion the wall of the flow cell, the turbulence that was present with the prior art is substantially reduced. The prior art arrangement of four electrodes within the center of the flow cell, as opposed to two electrodes in the same space as in the present invention, presented an interrupted flow passage producing turbulence in the areas of electrodes. Other prior art arrangements in which two sets of four electrodes were arranged along the axis of flow, with space between the two sets, generates even more turbulence.

The configuration of the present invention provides quiet, substantially laminar flow and no deleterious turbulence, giving a better flow dynamic for the effective operation of the electrodes. Turbulence is believed to have contributed to both the uneven erosion and rounding of operational surfaces in known systems as well as to the coating of the electrodes with impurities such as mineral deposits.

The electrodes of this invention also operate at consistently lower temperature than the prior art electrodes. Elimination of the rounding effect and coating allows the electrodes to operate at a lower voltage, thereby generating less heat.

Also, the thinner, uninterrupted electrode configuration provides one which dissipates the heat that is generated more readily. In summary, the inventive electrodes run more electrically efficient and cooler overall.

Other thickness, width and length combinations are possible so long as the opposed, continuous operating surfaces extending across the full width of the flow passage are maintained. Some such combinations are set forth below.

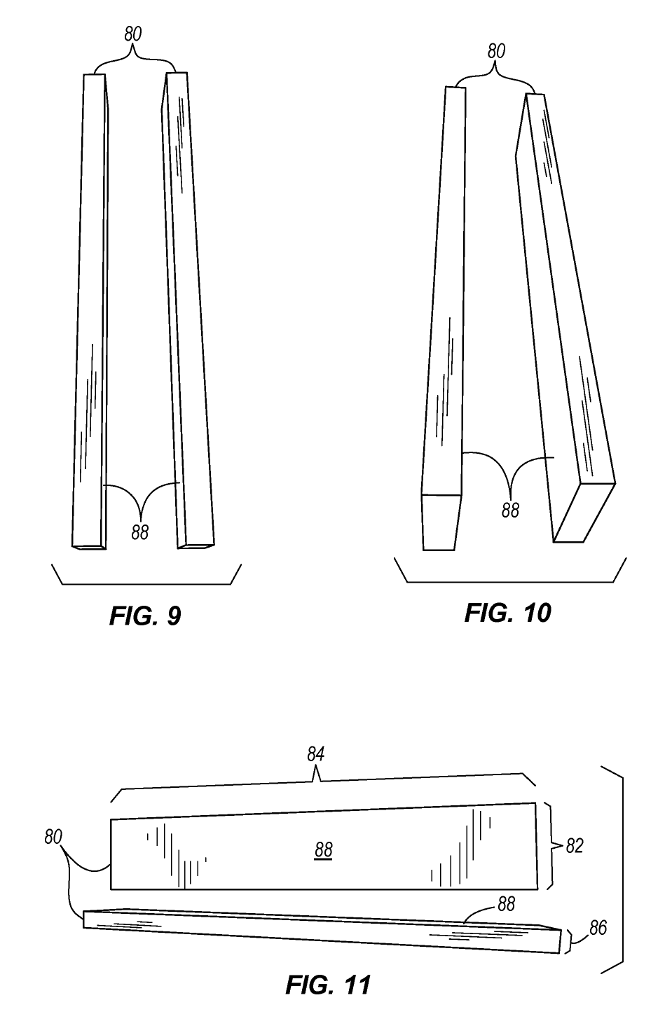

FIGS. 9, 10, and 11 show pairs of electrode plates 80 according to an embodiment of the invention. Each electrode plate 80 has a width 82, a length 84, and a thickness 86. The width 82 and length 84 define a face 88. In use, the pair of electrode plates 80 is mounted within a flow cell such that the faces 88 of each electrode plate 80 are parallel and opposite to one another, with a space or gap therebetween. It will be noted that with reference to the cross-sectional configuration of the flow cell, FIGS. 7, 8, 12, and 16, the width of the electrodes which extends across the cell is greater than the inner radius 160 of the cell at that cross section of the cell. In various embodiments, the ratio of the width of the electrode plate to the radius of the inner surface of the flow cell according to embodiments of the invention can include 1.1:1, 1.2:1, 1.3:1, 1.4:1, 1.5:1, 1.6:1, 1.7:1, 1.8:1, or 1.9:1. In one particular embodiment in which the inner radius of the flow cell is 1.9 inches and the width of the electrode plate is 2.5 inches, the ratio of the width of the electrode plate to the inner radius of the flow cell is 1.3.

Another measure for defining the configuration of the improved electrode configuration is, whereas the ratio of width to thickness in the prior art electrodes was 1:1, the ratio of width to thickness in accordance with some embodiments the present invention is in the range of 4:1. In various embodiments, the ratio of the width to the thickness is 1.1:1, 1.25:1, 1.5:1, 2:1, 3:1, 5:1, 10:1, or greater. In still other embodiments, the ratio is that which is embodied in the dimensions of the electrodes set forth below as alternative embodiments.

In some embodiments the fasteners protrude from the surfaces of the electrodes into the gap between the adjacent electrodes. However, in other embodiments, the opposing faces 48, 50 of the electrodes 40, 42 are substantially flat and free of any protrusions related to fasteners or other sources (e.g. FIGS. 12, 13, and 14).

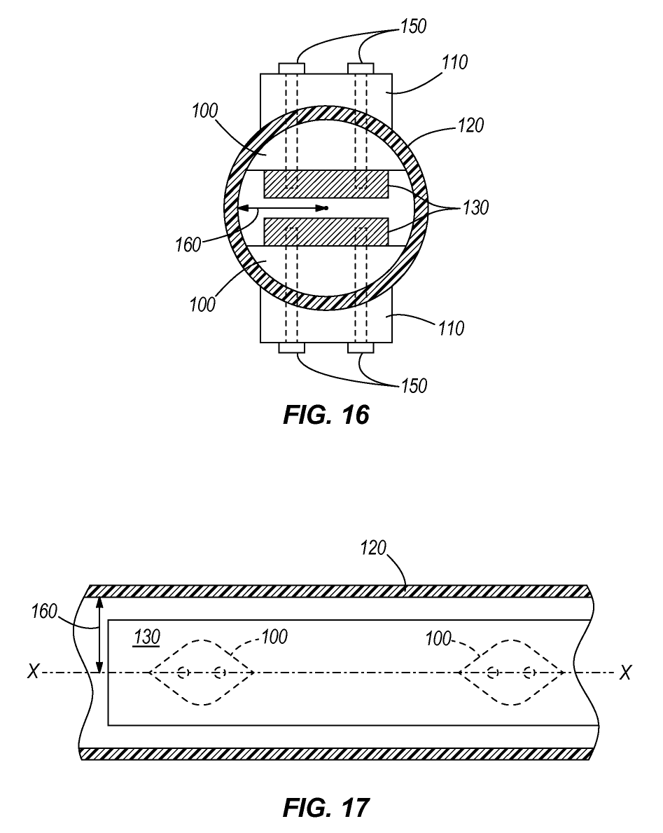

In some embodiments (e.g. FIG. 16), the electrodes are fastened adjacent to and in contact with one or more support blocks 100. In such embodiments, the liquid generally flows between the opposing faces of the electrode plates since the support blocks block liquid from flowing past the outer faces.

In other embodiments (e.g. FIG. 12), the electrodes are fastened at a distance from the support blocks using spacers 72, with the result that liquid can flow on either side of each of the electrodes. The spacers 72 may be used to adjust the distance between the opposing electrodes 46, 48, to optimize the electrical interactions between the electrodes 46, 48. In other embodiments, larger or smaller support blocks 100 may instead be used to adjust the distance between the opposing electrodes 46, 48, instead of using spacers 72. In certain embodiments, the gap between the opposing electrodes 46, 48 is three eighths of an inch, although larger or smaller gaps are also possible. In some embodiments, the size of the gap is reduced when the electrodes are used with water that has lower conductivity (e.g., distilled water) in order to maintain a particular current and voltage level across the electrodes.

In some embodiments (e.g. FIG. 16), the support blocks are semi-cylindrical with a curved face that is typically complementary to the inside surface of the flow cell and a flat face to which an electrode plate is attached.

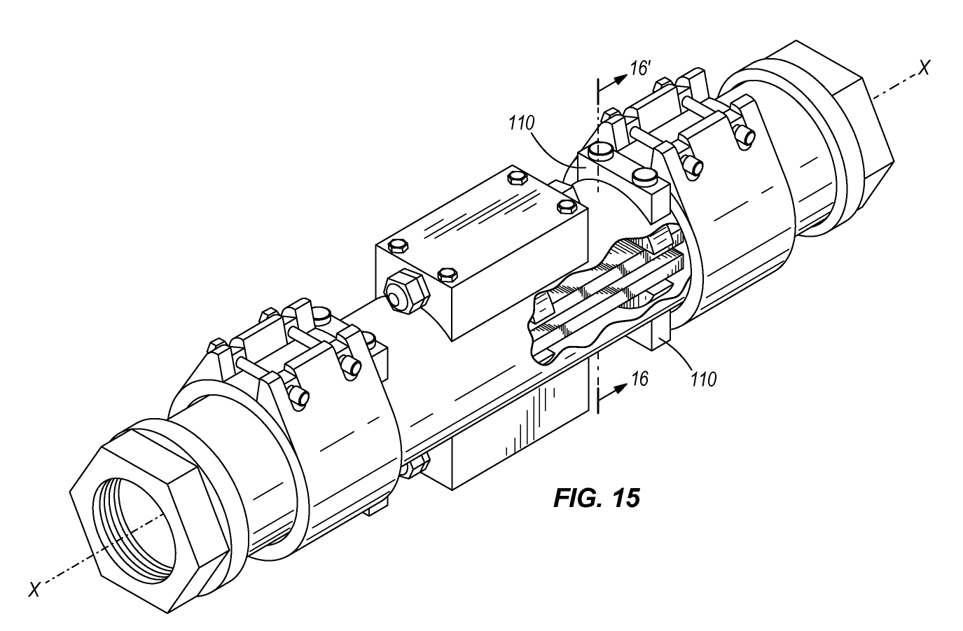

In other embodiments (FIG. 15), the support blocks 100 can include an outer portion 110 that is attached to the outside of the flow cell. In such embodiments, the fasteners run through the outer portion 110, through the flow cell, through an optional support block 100 inside the flow cell, and through and/or onto the electrode plate.

In still other embodiments, the support blocks 100 are diamond-shaped (FIG. 17) to allow liquid to flow more easily past the blocks 100. FIG. 17 shows a partial cutaway side view of a flow cell 120, cut parallel to the long axis X, in which the relative position of an electrode plate 130 and the support blocks 100 can be seen. In some embodiments, one or more corners of the blocks are beveled to further accommodate liquid flow past the blocks 100, in order to reduce turbulence and promote laminar flow even more.

The support blocks 100 typically have openings to accommodate fasteners 150 (FIG. 16). The fasteners 150 are generally made from electrically conductive material and run from outside the flow cell 120, through the support block, and into and/or through the electrode plate 130. In some embodiments, the electrode plate 130 may have a blind threaded bore into which the fasteners 150 can be threaded, such that the electrode plate 130 is mounted to the support blocks 100 and flow cell 120, while leaving the smooth planar facing surfaces of the electrode plate 130 unbroken by the fasteners. In other embodiments, the fasteners 150 run completely through the electrode plate 130 but the heads of the fasteners 150 have a low profile and/or are flush with the surface of the electrode plate 130, and the electrode plate 130 may be recessed or countersunk to permit the low profile or flush mounting of the head of the fastener 150. In some embodiments, the DC voltage is applied via the fasteners 150 to the electrode plates, while in other embodiments separate conductors are attached to the electrode plates to deliver DC voltages.

In one embodiment, the invention provides for a replacement or retrofit kit for a flow cell. The kit can include a pair of electrode plates, one or more support blocks for mounting the electrode plates to the flow cell, and one or more fasteners for attaching the electrode plates and support blocks to the flow cell.

What is claimed is:

1. A liquid purification apparatus, comprising:
a flow cell having an opening at each end for conducting a liquid therethrough; and
a pair of electrode plates disposed within the flow cell, each electrode plate comprising an elongated rectangle having a length, width, and thickness, the length and width defining a face of each electrode plate, the width being greater than the thickness,
wherein the electrode plates are arranged such that the faces of the electrode plates are parallel and opposite one another with a gap therebetween.

2. The liquid purification apparatus of claim 1, wherein the flow cell has a radius and the width of each electrode is greater than the radius.

3. The liquid purification apparatus of claim 1, wherein the length and thickness on either side of each electrode plate defines lateral edges, and wherein the lateral edges of each of the electrode plates are adjacent to an inner surface of the flow cell.

4. The liquid purification apparatus of claim 1, wherein a ratio of the width to the thickness of the electrode plate is at least four to one.

5. The liquid purification apparatus of claim 1, wherein the length is parallel to a long axis of the flow cell.

6. The liquid purification apparatus of claim 1, further comprising:
a pair of electrode support blocks disposed within the flow cell, each support block being situated between one of the electrodes and an inner surface of the flow cell; and
a plurality of electrically conductive fasteners for coupling the electrode plates and electrode support blocks to the inside of the flow cell.

7. The liquid purification apparatus of claim 1, further comprising:
a controller which supplies current to the electrode plates such that at least one of copper and silver ions are released from at least one of the electrode plates into the liquid.

8. The liquid purification apparatus of claim 1, wherein each electrode plate comprises an alloy of copper and silver.

9. The liquid purification apparatus of claim 8, wherein the alloy comprises 70% copper and 30% silver.

10. The liquid purification apparatus of claim 1, further comprising an electrode support block having at least one curved face opposite a flat face, the curved face being complementary to an inside surface of the flow cell.

11. A method of disinfecting a liquid, comprising:
providing a flow cell having an opening at each end for conducting a liquid therethrough;
disposing a pair of electrode plates disposed within the flow cell, each electrode plate comprising an elongated rectangle having a length, width, and thickness, the length and width defining a face of each electrode plate, the width being greater than the thickness, wherein the electrode plates are arranged such that the faces of the electrode plates are parallel and opposite one another with a gap therebetween;
applying a voltage to the electrode plates; and
contacting the electrode plates with the liquid.

12. The method of claim 11, wherein the flow cell has a radius and the width of each electrode is greater than the radius.

13. The method of claim 11, wherein the length and thickness on either side of each electrode plate defines lateral edges, and wherein the electrode plates are disposed within the flow cell such that the lateral edges of each of the electrode plates are adjacent to an inner surface of the flow cell.

14. The liquid purification apparatus of claim 11, wherein a ratio of the width to the thickness of the electrode plate is at least four to one.

15. The liquid purification apparatus of claim 11, wherein the length is parallel to a long axis of the flow cell.

16. The liquid purification apparatus of claim 11, further comprising:
disposing a pair of electrode support blocks disposed within the flow cell, each support block being situated between one of the electrodes and an inner surface of the flow cell; and
coupling the electrode plates and electrode support blocks to the inside of the flow cell using a plurality of electrically conductive fasteners.

17. The liquid purification apparatus of claim 11, wherein applying a voltage to the electrode plates further comprise attaching a controller to the electrode plates to supply current such that at least one of copper and silver ions are released from at least one of the electrode plates into the liquid.

18. The liquid purification apparatus of claim 11, wherein each electrode plate comprises an alloy of 70% copper and 30% silver.

19. The liquid purification apparatus of claim 11, further comprising an electrode support block having at least one curved face opposite a flat face, the curved face being complementary to an inside surface of the flow cell.
